(19) United States
(12) Patent Application Publication
(10) Pub. No.: US 2019/0100163 A1
(43) Pub. Date: Apr. 4, 2019

(54) GAS-BAG UNIT FOR A MOTOR VEHICLE

(71) Applicant: Joyson Safety Systems Germany GmbH, Aschaffenburg (DE)

(72) Inventor: Mirko KORTH, Ulm (DE)

(73) Assignee: Joyson Safety Systems Germany GmbH, Aschaffenburg (DE)

(21) Appl. No.: 16/145,103

(22) Filed: Sep. 27, 2018

(30) Foreign Application Priority Data
Sep. 29, 2017 (DE) 10 2017 217 499.4

(51) Int. Cl. B60R 21/207; B60R 21/237

(52) U.S. Cl. CPC B60R 21/207; B60R 21/26; B60R 21/237

(57) ABSTRACT

It is provided a gas-bag unit for a motor vehicle, having an inflatable gas bag which comprises at least two material layers that are fastened to one another by means of a circumferential seam in such a manner that the at least two material layers surround a gas-bag interior. A first portion of the gas bag is folded down to form a fold in such a manner that a first portion of the circumferential seam, which is located in the first portion of the gas bag, and the first portion of the gas bag are separated from the gas-bag interior by the fold.

### REFERENCE TO RELATED APPLICATION

This application claims priority to German Patent Application No. 10 2017 217 499.4 filed on Sep. 29, 2017, the entirety of which is incorporated by reference herein.

### BACKGROUND

The invention relates to a gas-bag unit for a motor vehicle.

A gas-bag unit of this type is used, for example, in airbag modules for motor vehicles or apparatuses for changing a seat contour of a vehicle seat. In an airbag module, a gas bag of the gas-bag unit is inflated in the event of an accident to protect a vehicle occupant. In the apparatus for changing the seat contour, which is arranged in particular in the seat or backrest region of the vehicle seat, the shape of the vehicle seat is changed by filling a gas bag with an adjustable quantity of a gas, as a result of which the shape of the gas bag and thus the seat contour is changed, this generally being defined as a comfort system.

In the case of an airbag module, there is often the problem that the gas for filling the gas bag enters into the gas bag at a high temperature and/or a high speed. As a result, a connection between the material layers which form the gas bag can be subjected to a high level of loading or can be damaged. On account of the frequent filling and venting, the gas bag (and in particular the connection between the material layers thereof) of the apparatus for changing a seat contour of a vehicle seat may be subjected to a high level of mechanical loading by the associated movement of the gas bag. Moreover, when sitting on the vehicle seat, a user exerts a permanent pressure on the gas bag. In both cases, there is the problem that, in the region of the connection of the two gas-bag layers, the gas bag under certain circumstances cannot withstand the mechanical loads at least in certain portions, and tears. Furthermore, in the case of gas bags which are produced by welding the material layers, there is the problem that the elasticity of the material changes in the welding region, as a result of which the risk of the material fracturing increases in this region.

### SUMMARY

This problem is solved by the provision of a gas-bag unit having features as described herein.

Accordingly, the invention provides a gas-bag unit for a motor vehicle, comprising an inflatable gas bag which comprises at least two material layers that are fastened to one another by means of a circumferential seam in such a manner that the at least two material layers surround a gas-bag interior. The material layers may comprise a woven fabric or a plastics material. The circumferential seam may be in the form of a sewn seam, welded seam or adhesive seam.

The gas-bag unit is characterized in that a first portion of the gas bag is folded down to form a fold in such a manner that a first portion of the circumferential seam, which is located in the first portion of the gas bag, and the first portion of the gas bag are separated from the gas-bag interior by the fold. This first portion of the circumferential seam thus has no direct contact with the gas-bag interior, and is subjected to a lower level of mechanical loading when the gas bag is being filled with gas, for example.

A gas generator can be provided for filling the gas bag with a gas, said gas generator being configured to provide gas for filling the gas bag. The gas generator has at least one outlet opening, through which the gas can flow from the gas generator into the gas-bag interior. In this case, the gas stream often has a main flow direction. Here, the fold of the gas bag can be arranged in such a manner in relation to the at least one outlet opening that the gas emerging from the gas generator is directed onto the fold. Expressed differently, the main flow direction of the gas stream extends from the at least one outlet opening to the fold. In this case, the fold and the main flow direction enclose an angle differing from 0°, preferably of +45° to −45°. It is thereby possible to prevent the gas stream, which under certain circumstances is hot, from impinging on the first portion of the circumferential seam and the woven fabric of the material layers which directly surrounds the first portion of the circumferential seam, and from weakening the latter by virtue of its temperature or its impulse. Instead, said first portion of the circumferential seam is protected from direct impingement of the gas stream by the fold. Without the fold, the first portion of the circumferential seam (and/or the woven fabric of the material layers which directly surrounds the first portion of the circumferential seam) would be exposed to the gas stream of the gas generator to a greater extent, and therefore would be subjected to greater mechanical loading, compared to the rest of the circumferential seam, on account of its position with respect to the at least one outlet opening of the gas generator. The strength of this region would therefore be at risk owing to the gas stream.

In particular, the at least one outlet opening of the gas generator can be oriented in such a manner that the gas emerging from the gas generator is not directed onto the circumferential seam. Here, the fold can be dimensioned, shaped and arranged in such a manner that the gas stream is directed directly onto the fold, and not onto a portion of the circumferential seam which lies outside the first portion of the circumferential seam. The fold in this respect protects the first portion of the circumferential seam.

It is conceivable for the fold to be formed in the inflated and in the non-inflated state of the gas bag. This means that the fold is retained during inflation (venting) of the gas bag, such that it can protect the first portion of the circumferential seam in particular during the inflation process.

The fold can hinder the gas stream in such a manner that the latter flows only with difficulty into the first portion of the gas bag. In order to fill the gas bag with gas beyond the fold, that is to say the first portion of the gas bag, the originally directed gas stream would have to change its direction. In the region of the fold, however, the impulse of the gas stream is reduced, and therefore the gas flows in a rather diffuse manner into the first portion of the gas bag. Therefore, the first portion of the gas bag cannot be inflated or can only be inflated slightly by the gas flowing from the gas generator. As a result, the first portion of the circumferential seam is subjected to a lower level of mechanical loading.

According to one embodiment, the first portion of the gas bag can be fixed in relation to the rest of the gas bag. By way of example, the first portion of the gas bag can thus be fixed on a material layer in the region of the rest of the gas bag.

The first portion of the gas bag can comprise a portion of each of the at least two material layers, which are fastened to one another by the first portion of the circumferential seam.

The invention also relates to an airbag module and to an apparatus for changing a seat contour of a vehicle seat, each with the gas-bag unit according to the invention.

### BRIEF DESCRIPTION OF THE DRAWINGS

The invention will be explained in more detail hereinbelow on the basis of exemplary embodiments and with reference to the figures.

FIG. 1 shows a plan view onto a gas-bag unit according to one embodiment of the invention.

FIG. 2 shows a section of a side view of the gas-bag unit according to the embodiment of the invention shown in FIG. 1.

### DETAILED DESCRIPTION

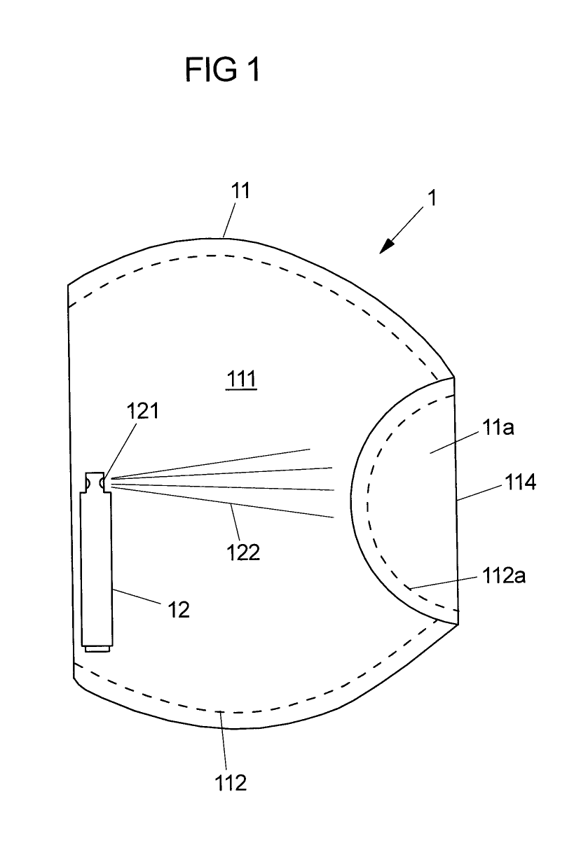

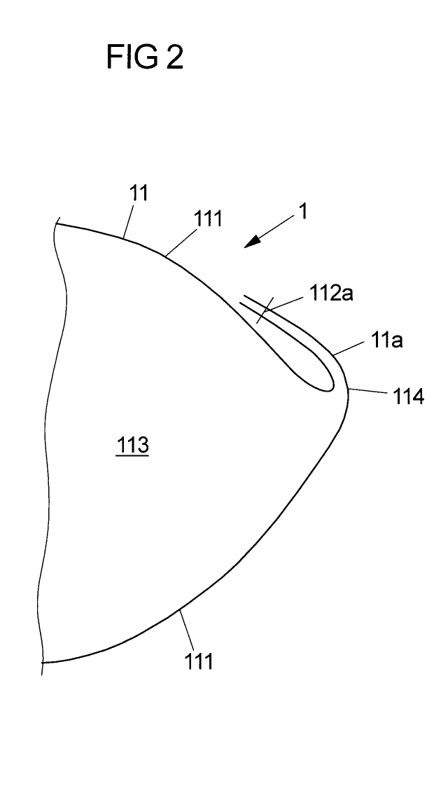

FIG. 1 shows a plan view of a gas-bag unit 1 for an airbag module. The gas-bag unit 1 comprises an inflatable gas bag 11, which comprises two material layers of a woven fabric. FIG. 1 shows the gas bag 11 in the non-inflated state. The two material layers 111 are fastened to one another by means of a circumferential seam 112 in the marginal region of the material layers 111. The material layers 111 are formed from a woven fabric portion which is turned down. Along the free circumferential edge (outside the circumferential edge formed by the turning-down), the material layers 111 are fastened to one another by the circumferential seam 112. Here, the circumferential seam 112 is a sewn seam. Alternatively, two separate material layers may be provided, these being fastened to one another along their entire circumferential edge by a circumferential seam (in the form of a sewn seam). The two material layers enclose a gas-bag interior. A gas generator 12 having at least one outlet opening 121 is provided, a gas stream 122 flowing through said outlet opening into the gas-bag interior 113 and inflating the latter. Here, the gas stream 122 is directed onto a fold 114. The fold is formed by folding down a first portion 11a of the gas bag 11. In this case, the first portion 11a of the gas bag 11 comprises in each case a portion of the two material layers 111. The material layers 111 of the first portion 11a are held together by a first portion 112a of the circumferential seam 112. The fold 114 separates the first portion 112a of the circumferential seam 112, which is located in the first portion 11a of the gas bag 11, and the first portion 11a of the gas bag 11 from the gas-bag interior 113. The fold 114 makes it possible to prevent the gas stream 122 from impinging directly on the first portion 112a of the circumferential seam 112 (and thus on the region which is originally at risk in terms of strength), and from damaging the circumferential seam under certain circumstances by virtue of it impulse and/or its temperature. Instead, the gas stream 122 impinges on the fold 114, the latter protecting the first portion 112a of the circumferential seam 112 located therebehind (as considered in the direction of flow of the gas stream) by virtue of the fact that the thermal and/or mechanical energy of the gas stream is distributed over the woven fabric and the rest of the circumferential seam outside the first portion 112a of the circumferential seam 112. The fold 114 moreover prevents the first portion 11a of the gas bag 11 from being inflated, and the material layers 111 from being displaced significantly in said first portion 11a with respect to one another and with respect to the first portion 112a of the circumferential seam. The fold 114 thus separates the inflatable or inflated gas-bag interior 113 from the non-inflatable first portion 11a of the gas bag 11. The gas-bag interior should be defined only as being that part which is inflatable or inflated by gas. By way of example, the size of the fold 114 can vary depending on the size of the gas bag, the way in which the gas stream is directed, or the nature of the gas stream. Therefore, the fold may extend over a few millimetres or over the entire extent of the gas bag along one direction. Similarly, the number of folds 114 formed may vary in order to protect further portions of the gas bag which are subjected to mechanical loading. That is to say that one or more folds 114 may be present for each gas bag 11, it also being possible for these to overlap or intersect for example. The folds 114 can thus be arranged in such a manner that they substantially determine the shape of the circumferential edge of the gas bag 11 and therefore the design of the gas bag 11. FIG. 2 shows a section of the gas-bag unit shown in FIG. 1 in an inflated state, the gas generator not being arranged in the section depicted.

The gas-bag unit shown in FIGS. 1 and 2 is similarly suitable for an apparatus for changing a seat contour of a vehicle seat. Instead of a gas generator, the gas-bag unit for an apparatus for changing a seat contour of a vehicle seat may have a gas-conducting device (not shown), this being designed to conduct gas into the gas-bag interior. The gas- conducting device can be connected to a gas source arranged outside the gas bag. By way of example, the gas-conducting device can be configured in the form of a hose feed protruding through an opening of the gas bag into the gas-bag interior. Furthermore, the material layers can be manufactured from a plastics material, the circumferential seam being a welded seam for example. The fold 114 protects the first portion 112a of the circumferential seam 112 against permanent movement of the material layers and the associated gradual destruction (material cracking, seam fracture) of the first portion 112a of the circumferential seam.

1. A gas-bag unit for a motor vehicle, having an inflatable gas bag which comprises at least two material layers that are fastened to one another by means of a circumferential seam in such a manner that the at least two material layers surround a gas-bag interior, wherein a first portion of the gas bag is folded down to form a fold in such a manner that a first portion of the circumferential seam, which is located in the first portion of the gas bag, and the first portion of the gas bag are separated from the gas-bag interior by the fold.

2. The gas-bag unit according to claim 1, wherein a gas generator is provided and is configured to provide gas for filling the gas bag, wherein the gas generator has at least one outlet opening, through which the gas flows from the gas generator into the gas-bag interior, and wherein the fold is arranged in such a manner in relation to the at least one outlet opening that the gas emerging from the gas generator is directed onto the fold.

3. The gas-bag unit according to claim 2, wherein the at least one outlet opening of the gas generator is oriented in such a manner that the gas emerging from the gas generator is not directed onto the circumferential seam.

4. The gas-bag unit according to claim 1, wherein the fold is formed in the inflated and in the non-inflated state of the gas bag.

5. The gas-bag unit according to claim 2, wherein the first portion of the gas bag cannot be inflated or can only be inflated slightly by the gas flowing from the gas generator.

6. The gas-bag unit according to claim 1, wherein the first portion of the gas bag is fixed in relation to the rest of the gas bag.

7. The gas-bag unit according to claim 1, wherein the first portion of the gas bag comprises a portion of each of the at least two material layers, which are fastened to one another by the first portion of the circumferential seam.

8. The gas-bag unit according to claim 1, wherein a plurality of first portions of the gas bag are folded down to form one or more fold(s).

9. The gas-bag unit according to claim 1, wherein a gas-conducting device is provided and is configured to conduct gas for filling the gas bag into the gas-bag interior, wherein the gas-conducting apparatus is formed in particular as a hose feed.

10. A vehicle occupant restraint system having a gas-bag unit which comprises an inflatable gas bag, wherein the gas-bag unit is a gas-bag unit according to claim 1.

11. An apparatus for changing a seat contour of a vehicle seat having a gas-bag unit which comprises an inflatable gas bag, wherein the gas-bag unit is a gas-bag unit according to claim 1.
